(19) United States
(12) Patent Application Publication
(10) Pub. No.: US 2024/0290328 A1
(43) Pub. Date: Aug. 29, 2024

(54) AI-based sound recognition module and sound recognition camera using the same

(71) Applicant: KUM SAN KOREA CO., LTD., Seoul (KR)

(72) Inventor: HA JUN LEE, Seoul (KR)

(21) Appl. No.: 18/586,590

(22) Filed: Feb. 26, 2024

(30) Foreign Application Priority Data
Feb. 27, 2023 (KR) 10-2023-0026169

(51) Int. Cl. G10L 15/20

(52) U.S. Cl. CPC G10L 15/20

(57) ABSTRACT

The AI-based sound recognition module includes: a noise removal unit for removing a noise waveform from a sound based on direction information, and outputting a result of the removal; a voice recognition unit for recognizing only a sound from a waveform output from the noise removal unit, and outputting a recognized audio signal; and a sound recognition unit for processing the audio signal to output a voice detection signal, wherein the sound recognition unit extracts a feature from an input audio signal to convert the extracted feature into a pattern vector for teaching or recognition, stores the pattern vector obtained through the conversion in a neuron library, recognizes a pattern of the pattern vector with a sound recognition model generated through library teaching, standardizes the recognized pattern, makes a global decision on the pattern, and outputs a result of the global decision as the voice detection signal.

### BACKGROUND OF THE INVENTION

### 1. Field of the Invention

The present invention relates to an artificial intelligence (AI)-based sound recognition module and a sound recognition camera using the same, and more particularly, to an AI-based sound recognition module and a sound recognition camera using the same, capable of recognizing approach of an object (a motorcycle, a car, a person, an animal, etc.), which may not be viewed from perspectives of a vehicle driver and a camera, with respect to a car through sound recognition, and notifying the driver of the approach to prevent an accident.

### 2. Description of the Related Art

In recent years, there has been an increase in the advancement of intelligent cars that emphasize driving convenience and safety, and as one of such trends, various driver assistance systems (DASs) for assisting drivers to allow the drivers to drive comfortably are being mounted on the intelligent cars.

Among such DASs, there are camera sensors. The camera sensor may provide a safer driving environment by detecting front, rear, left, and right spaces including blind spots that may not be recognized by the driver.

The camera sensors may be classified into three categories according to monitoring areas thereof.

First, the camera sensor may be mounted for front monitoring to receive an image on a front side of the car, and such a system may detect a lane on the front side or a vehicle on the front side during driving to maintain the lane, prevent forward collision, and the like. Second, the camera sensor may be provided for side and rear monitoring to detect images of blind spots including left and right sides of the car so as to prevent rear-end collision upon changing lanes, monitor the blind spots, and the like. Third, the camera sensor may be mounted for rear monitoring to receive an image on a rear side of the car to detect the rear side upon reversing or parking and the like.

For example, a front camera sensor may detect an image of a driving road on the front side to transmit an image signal corresponding to the detected image to an electronic control unit (ECU), and the ECU may analyze the transmitted image signal of the driving road to detect a lane of the driving road, and may determine whether a driving vehicle has deviated from the driving road or a driving lane based on a detected lane image.

A left rear camera sensor and a right rear camera sensor may detect images on left rear and right rear sides the car to transmit image signals corresponding to the detected images to the ECU, and the ECU may analyze the image signals of the driving road transmitted from the sensor and image signals of other vehicles to detect the lane of the driving road and distances to other vehicles, and may notify of the possibility of the driving vehicle deviating from the driving road, a risk of collision with other vehicles, or the like based on detected lane images and the image signals of other vehicles.

A rear camera sensor may be installed on the rear side of the car to detect an image on the rear side to transmit an image signal corresponding to the detected image to the ECU, and the ECU may analyze the image signal of the driving road and the image signals of other vehicles, and may notify of a risk of rear-end collision or the like based on a detected image and the image signals.

However, various camera devices mounted on the car may capture only an object that is visible in a field of view of a camera, and perform warning only for object information in captured image information.

For example, when an object approaches a car in an alley or the like that is not visible in a field of view of a camera on a road on which the car is being driven, a driver may not recognize the object so that the car may frequently collide with the approaching object, resulting in an accident.

### DOCUMENTS OF RELATED ART

### Patent Documents

(Patent Document 0001) Korean Patent Registration No. 10-1276385 (registered on Jun. 12, 2013) (Safety Notification System for Pedestrian Crossing without Permission Using Thermal Imaging Camera and Method for Using the Same)
(Patent Document 0002) Korean Unexamined Patent Publication No. 10-2020-0084470 (published on Jul. 13, 2020) (Intelligent Side View Camera System for Vehicle)
(Patent Document 0003) Korean Unexamined Patent Publication No. 10-2022-0123159 (published on Sep. 6, 2022) (Vehicle Control Apparatus and Method Using Side Camera)
(Patent Document 0004) Korean Unexamined Patent Publication No. 10-2022-0058001 (published on May 9, 2022) (Pedestrian Safety Support Method Using Vehicle Camera and System Therefor)

### SUMMARY OF THE INVENTION

Therefore, the present invention has been proposed to solve the problems occurring in a general camera system for a car and a conventional camera system applied to a car as described above, and an object of the present invention is to provide an AI-based sound recognition module and a sound recognition camera using the same, capable of recognizing approach of an object (a motorcycle, a car, a person, an animal, etc.), which may not be viewed from perspectives of a vehicle driver and a camera, with respect to a car through sound recognition, and notifying the driver of the approach to prevent an accident.

To achieve the object described above, according to the present invention, there is provided “an AI-based sound recognition module” including:
a noise removal unit for removing a noise waveform from a sound input through a microphone based on direction information, and outputting a result of the removal;
a voice recognition unit for recognizing only a sound from a waveform output from the noise removal unit, and outputting a recognized audio signal; and
a sound recognition unit for processing the audio signal output from the voice recognition unit through a neuron artificial neural network to output a voice detection signal, wherein the sound recognition unit extracts a feature from an input audio signal to convert the extracted feature into a pattern vector for teaching or recognition, stores the pattern vector obtained through the conversion in a neuron library, recognizes a pattern of the pattern vector with a sound recognition model generated through library teaching, standardizes the recognized pattern, makes a global decision on the pattern, and outputs a result of the global decision as the voice detection signal.

In this case, the noise removal unit may include:
a plurality of microphones spaced apart from each other at a predetermined interval to determine directionality of the input sound;
a coherence function generation unit for calculating coherences of the input sound according to microphone intervals, respectively, calculating averages of the coherences for each identical distance, filtering the calculated averages of the coherences, and outputting the filtered averages of the coherences; a spatial filter coefficient calculation unit for calculating a spatial filter coefficient by using the filtered averages of the coherences to output the calculated spatial filter coefficient; and a beamforming performance unit for performing beamforming on an input signal by using the spatial filter coefficient to output a noise-processed signal.

In this case, the coherence function generation unit may include:
a coherence calculation unit for calculating the coherences of the input signal according to microphone intervals in a noise period, respectively, and outputting the calculated coherences; a coherence average calculation unit for calculating average values of the coherences input from the coherence calculation unit for each identical distance, and outputting the calculated average values of the coherences; and a filter unit for filtering the average values of the coherences to smooth out a rapid change according to a frequency, and outputting the filtered average values of the coherences.

In this case, the sound recognition unit may include:
a CMOS connector for receiving the audio signal;
a field-programmable gate array (FPGA) for extracting the feature from the audio signal input through the CMOS connector to convert the extracted feature into the pattern vector for the teaching or the recognition; and
a pattern recognition unit for storing the pattern vector converted by the FPGA in the neuron library, recognizing the pattern of the pattern vector with the sound recognition model generated through the library teaching, and transmitting a recognition result to the FPGA, and
the FPGA may standardize the pattern recognized by the pattern recognition unit, make the global decision on the pattern, and output the result of the global decision as the voice detection signal.

In this case, the sound recognition unit may
receive an image acquired through a camera, preprocess the received image to convert the image into a recognition image, and recognize the recognition image obtained through the conversion to output the recognized recognition image as an image detection signal.

In addition, according to the present invention, there is provided “a sound recognition camera using an AI-based sound recognition module” including:
the sound recognition module including a noise removal unit for removing a noise waveform from a sound input through a microphone based on direction information and outputting a result of the removal, a voice recognition unit for recognizing only a sound from a waveform output from the noise removal unit and outputting a recognized audio signal, and a sound recognition unit for processing the audio signal output from the voice recognition unit through a neuron artificial neural network to output a voice detection signal;
an image input unit for receiving an image acquired through a camera, preprocessing the received image to convert the image into a recognition image, and transmitting the recognition image to the sound recognition module;
a control unit for controlling warning and display based on the voice detection signal output from the sound recognition module; and
a warning and display device for performing the warning and display based on voice sound detection according to a warning and display control signal generated by the control unit,
wherein the sound recognition module recognizes the recognition image converted by the image input unit to output the recognized recognition image as an image detection signal,
the control unit controls the warning and display based on the image detection signal, and
the warning and display device performs the warning and display based on image detection.

In this case, the noise removal unit may include:
a plurality of microphones spaced apart from each other at a predetermined interval to determine directionality of the input sound;
a coherence function generation unit for calculating coherences of the input sound according to microphone intervals, respectively, calculating averages of the coherences for each identical distance, filtering the calculated averages of the coherences, and outputting the filtered averages of the coherences;
a spatial filter coefficient calculation unit for calculating a spatial filter coefficient by using the filtered averages of the coherences to output the calculated spatial filter coefficient; and
a beamforming performance unit for performing beamforming on an input signal by using the spatial filter coefficient to output a noise-processed signal.

In this case, the sound recognition unit may include:
a CMOS connector for receiving an image signal and the audio signal;
a field-programmable gate array (FPGA) for extracting a feature from the audio signal input through the CMOS connector to convert the extracted feature into a pattern vector for teaching or recognition, preprocessing the image signal, and recognizing the image signal with an image recognition model; and
a pattern recognition unit for storing the pattern vector converted by the FPGA in a neuron library, recognizing a pattern of the pattern vector with a sound recognition model generated through library teaching, and transmitting a recognition result to the FPGA, and
the FPGA may standardize the pattern recognized by the pattern recognition unit, make a global decision on the pattern, output a result of the global decision as the voice detection signal, and output an image recognition result obtained through the recognition by using the image recognition model.

According to the present invention, approach of an object (a motorcycle, a car, a person, an animal, etc.), which may not be viewed from perspectives of a vehicle driver and a camera, with respect to a car may be recognized through sound recognition, and the driver may be notified of the approach, so that a vehicle accident can be prevented by raising awareness of an invisible object.

### BRIEF DESCRIPTION OF THE DRAWINGS

FIG. 1 is a view showing a configuration of an AI-based sound recognition module according to the present invention.

FIG. 2 is a view showing a configuration of a sound recognition camera using an AI-based sound recognition module according to the present invention.

FIG. 3 is a view showing a configuration of a noise removal unit of FIGS. 1 and 2 according to an embodiment.

FIG. 4 is a view showing a configuration of a sound recognition unit of FIGS. 1 and 2 according to an embodiment.

FIG. 5 is an example of a sound recognition process according to the present invention.

FIG. 6 is a flowchart of a sound recognition process of a sound recognition algorithm according to the present invention.

### DETAILED DESCRIPTION OF THE INVENTION

Hereinafter, an AI-based sound recognition module and a sound recognition camera using the same according to an exemplary embodiment of the present invention will be described in detail with reference to the accompanying drawings.

Terms and words used in the present invention that will be described below shall not be interpreted as being limited to general or dictionary meanings, but shall be interpreted as having meanings and concepts consistent with the technical idea of the present invention based on the principle that the inventor may appropriately define the concept of the term to describe his/her own invention in the best way.

Therefore, embodiments disclosed in the specification and the configurations depicted in the drawings are only exemplary embodiments of the present invention, and do not represent all of the technical idea of the present invention, so it should be understood that various equivalents and modification examples may be substituted for the embodiments and the configurations at the time of filing of the present application.

According to the present invention, an AI-based sound recognition module may be implemented as a standalone product so as to be attached to an existing installed camera to enable sound recognition (Embodiment 1), or an AI-based sound recognition module may be added to an existing implemented camera to enable sound recognition (Embodiment 2), which will be described separately.

### Embodiment 1

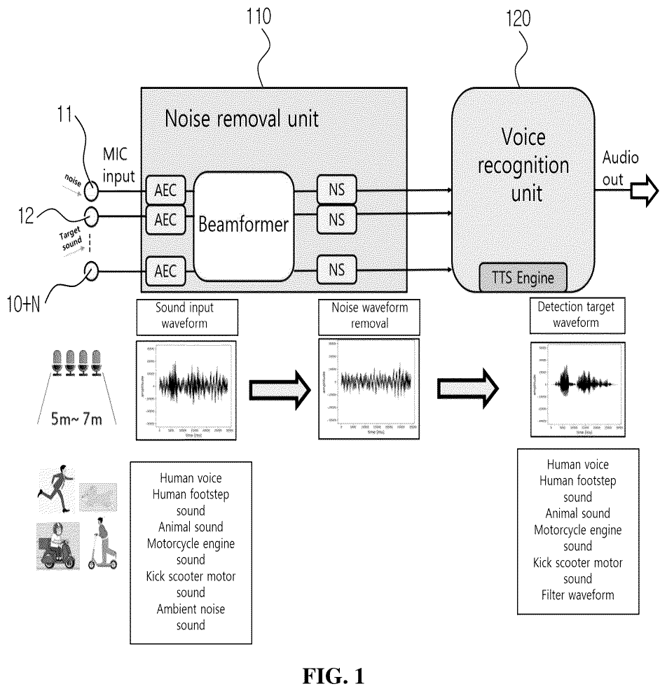

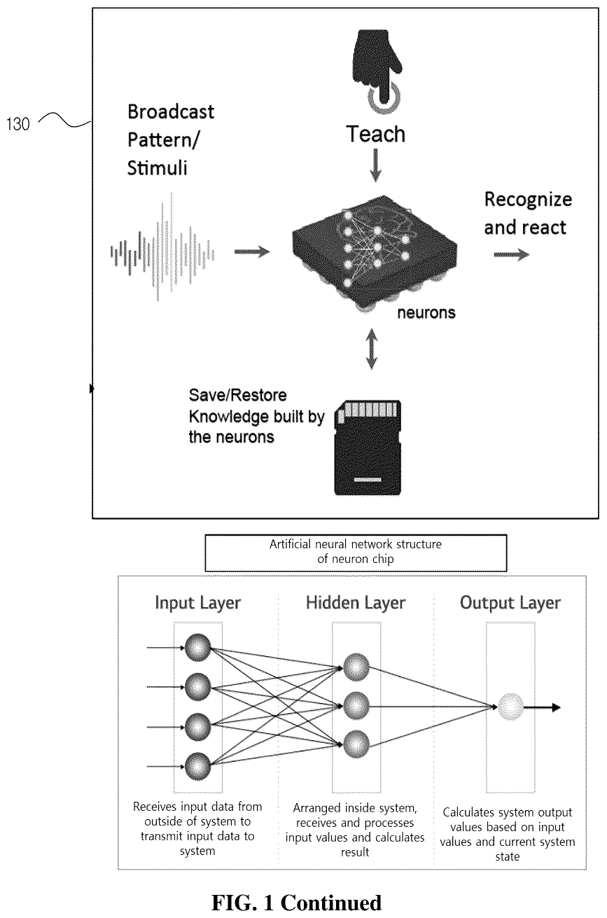

FIG. 1 is a view showing a configuration of an AI-based sound recognition module according to an exemplary embodiment of the present invention, and an AI-based sound recognition module may include a noise removal unit 110, a voice recognition unit 120, and a sound recognition unit 130.

The noise removal unit 110 may serve to remove a noise waveform from sounds input through microphones 10 to 10+N based on direction information, and output a result of the removal.

The noise removal unit 110 may include a plurality of microphones 10 to 10+N spaced apart from each other at a predetermined interval to determine directionality of the input sound, and as shown in FIG. 3, the noise removal unit 110 may include: a coherence function generation unit 111 for calculating coherences of the input sound according to intervals of the microphones 10 to 10+N, respectively, calculating averages of the coherences for each identical distance, filtering the calculated averages of the coherences, and outputting the filtered averages of the coherences; a spatial filter coefficient calculation unit 112 for calculating a spatial filter coefficient by using the filtered averages of the coherences to output the calculated spatial filter coefficient; and a beamforming performance unit 113 for performing beamforming on an input signal by using the spatial filter coefficient to output a noise-processed signal.

The coherence function generation unit 111 may include: a coherence calculation unit 111a for calculating the coherences of the input signal according to microphone intervals in a noise period, respectively, and outputting the calculated coherences; a coherence average calculation unit 111b for calculating average values of the coherences input from the coherence calculation unit 111a for each identical distance, and outputting the calculated average values of the coherences; and a filter unit 111c for filtering the average values of the coherences to smooth out a rapid change according to a frequency, and outputting the filtered average values of the coherences.

The voice recognition unit 120 may recognize only a sound from a waveform output from the noise removal unit 110, and output a recognized audio signal.

The sound recognition unit 130 may process the audio signal output from the voice recognition unit 120 through a neuron artificial neural network, which is artificial intelligence (AI), to output a voice detection signal.

The sound recognition unit 130 may extract a feature from an input audio signal to convert the extracted feature into a pattern vector for teaching or recognition, store the pattern vector obtained through the conversion in a neuron library, recognize a pattern of the pattern vector with a sound recognition model generated through library teaching, standardize the recognized pattern, make a global decision on the pattern, and output a result of the global decision as the voice detection signal.

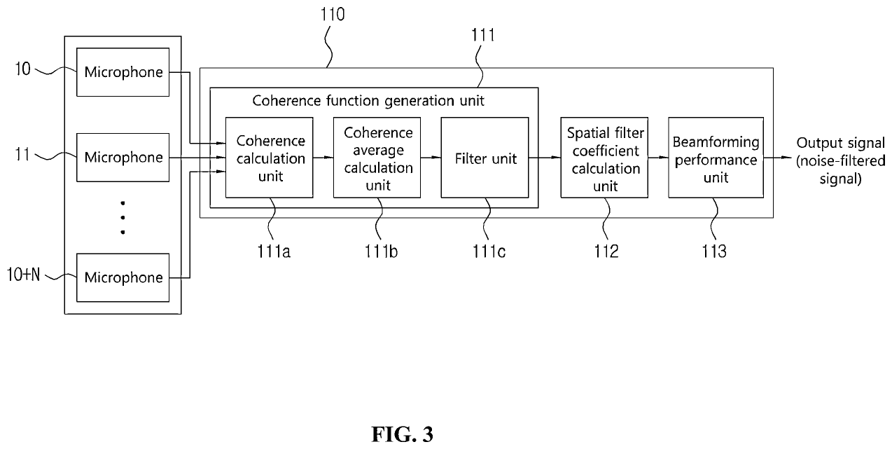

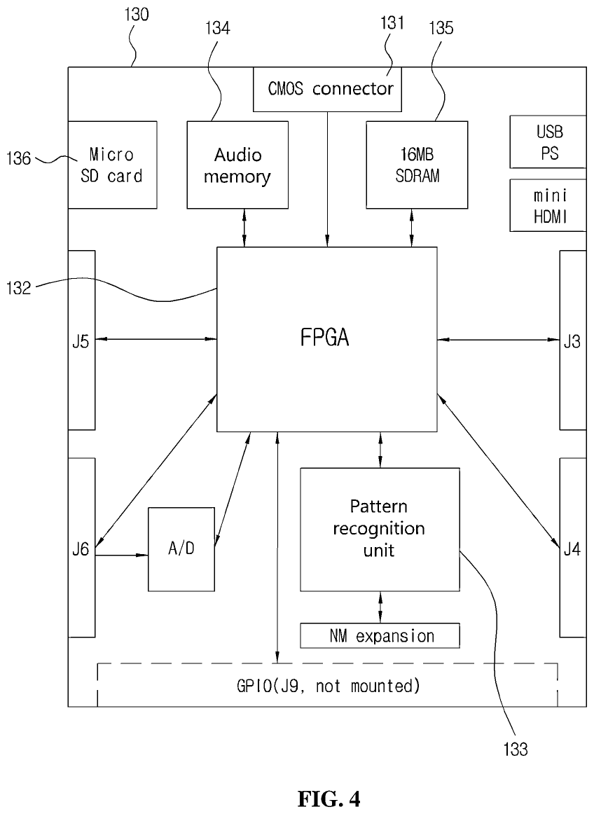

As shown in FIG. 4, the sound recognition unit 130 may include: a CMOS connector 131 for receiving the audio signal; a field-programmable gate array (FPGA) 132 for extracting the feature from the audio signal input through the CMOS connector 131 to convert the extracted feature into the pattern vector for the teaching or the recognition; and a pattern recognition unit 133 for storing the pattern vector converted by the FPGA 132 in the neuron library, recognizing the pattern of the pattern vector with the sound recognition model generated through the library teaching, and transmitting a recognition result to the FPGA 132.

In this case, the FPGA 132 may standardize the pattern recognized by the pattern recognition unit 133, make the global decision on the pattern, and output the result of the global decision as the voice detection signal.

In addition, the sound recognition unit 130 may include an audio memory 134 for storing audio data, an SDRAM 135 for storing data, a micro SD card 136, a USB terminal, an HDMI terminal, sensor connection terminals J3 to J6 for connecting various sensors, and the like.

An operation of the AI-based sound recognition module according to the exemplary embodiment of the present invention configured as described above will be described in detail as follows.

First, in order to recognize an object (a motorcycle, a car, a person, an animal, etc.) approaching a driving car from a blind spot of a camera or a location that may not be viewed from a perspective of a driver by a sound, the AI-based sound recognition module may be mounted on the car. In this case, an example in which the AI-based sound recognition module is mounted on the car for use will be described according to the present invention, but the present invention is not limited thereto, and it will be obvious to a person having ordinary skill in the art that the present invention may be applied to any device that warns of approach of an object through sound recognition for use.

While the AI-based sound recognition module is mounted, when the car starts driving so that the AI-based sound recognition module starts operating, the noise removal unit 110 may remove the noise waveform from the sounds input through a plurality of microphones 10 to 10+N spaced apart from each other at the predetermined interval based on the direction information, and output the result of the removal. In this case, since the microphones have directionality, a sound input direction may be estimated by processing signals of such directional microphones.

The noise removal unit 110 may remove an echo of an input sound signal by using an acoustic echo canceller (AEC) at a front end before the beamforming.

Regarding the input sound signal from which the echo is removed, the coherence function generation unit 111 of the noise removal unit 110 may calculate the coherences of the input sound according to the intervals of the microphone 10 to 10+N, respectively, calculate the averages of the coherences for each identical distance, filter the calculated averages of the coherences, and output the filtered averages of the coherences.

In other words, the coherence calculation unit 111a of the coherence function generation unit 111 may calculate the coherences of the input signal according to the microphone intervals in the noise period, respectively, and output the calculated coherences.

Next, the coherence average calculation unit 111b may calculate average values of the coherences input from the coherence calculation unit 111a for each identical distance, and output the calculated average values of the coherences. The average values calculated by the coherence average calculation unit 111b may be average values of the coherences calculated for each identical distance between the microphones.

Next, the filter unit 111c may filter the average values of the coherences to smooth out a rapid change according to a frequency, and output the filtered average values of the coherences.

In this case, the filter unit 111c may filter the average values of the coherences by using one scheme among a scheme of applying a moving average filter, a scheme of performing Fourier transform on a coherence function and applying a low-pass filter, a scheme of using a median filter, and a scheme of using a one-dimensional Gaussian smoothing filter.

Next, the spatial filter coefficient calculation unit 112 may calculate the spatial filter coefficient by using the averages of the coherences filtered through the filter unit 111c to output the calculated spatial filter coefficient. The spatial filter coefficient may be calculated simply by using a coherence matrix.

Next, the beamforming performance unit 113 may perform the beamforming on the input signal by using the spatial filter coefficient to output the noise-processed signal.

In other words, sound input direction information may be used to remove abnormal noise such as a human voice and a music signal.

The noise-processed signal may be output through a noise suppressor (NS).

Next, the voice recognition unit 120 may recognize only the sound from the waveform from which the noise is removed by the noise removal unit 110, and transmit the recognized audio signal to the sound recognition unit 130. In other words, the waveform from which the noise is removed may be filtered with a preset filter to recognize and output only sounds such as a human voice, a human footstep sound, a motorcycle engine sound, an animal sound, and a kick scooter motor sound.

The sound recognition unit 130 may process the audio signal output from the voice recognition unit 120 through the neuron artificial neural network, which is the artificial intelligence (AI), to output the voice detection signal.

The sound recognition unit 130 may extract the feature from the input audio signal to convert the extracted feature into the pattern vector for the teaching or the recognition, store the pattern vector obtained through the conversion in the neuron library, recognize the pattern of the pattern vector with the sound recognition model generated through the library teaching, standardize the recognized pattern, make the global decision on the pattern, and output the result of the global decision as the voice detection signal.

The sound recognition unit 130 may serve to distinguish and classify types of the input audio signal, that is, types of input sounds such as a footstep sound, a motorcycle sound, an animal sound, and a kick scooter sound.

For example, the sound recognition unit 130 may receive the audio signal output from the voice recognition unit 120 through the CMOS connector 131.

Next, the FPGA 132 may extract the feature from the audio signal input through the CMOS connector 131 to convert the extracted feature into the pattern vector for the teaching or the recognition, and transmit the pattern vector to the pattern recognition unit 133, which is an artificial intelligence neural network.

The pattern recognition unit 133 may store the pattern vector converted by the FPGA 132 in the neuron library, recognize the pattern of the pattern vector with the sound recognition model generated through the library teaching, and transmit the recognition result to the FPGA 132.

The pattern recognition may be described in more detail as follows.

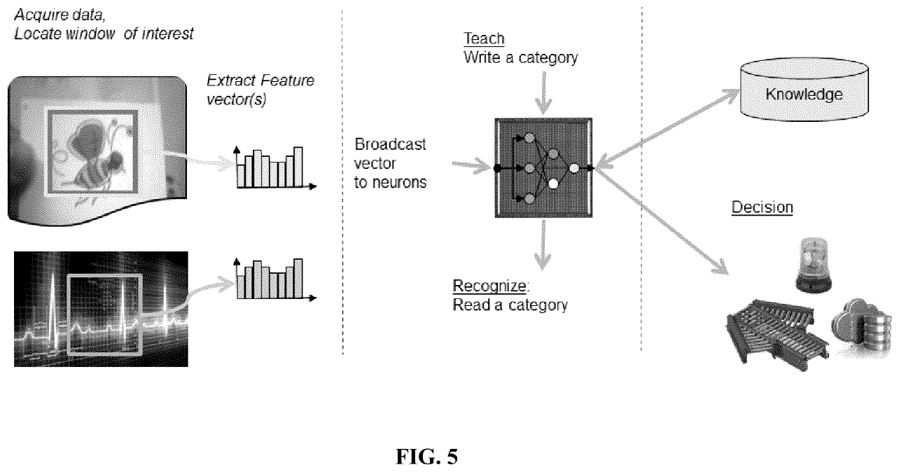

As shown in FIG. 5, the FPGA 132 may extract the feature from the input audio signal (digital audio data) to convert the extracted feature into a 256-byte pattern vector for the teaching or the recognition. The pattern vector may be broadcast to neurons of NeuroMem, which is an artificial intelligence neural network of the pattern recognition unit 133. The reason the pattern vector is broadcast is for the teaching or the recognition.

Next, the neurons of NeuroMem, which is the artificial intelligence neural network of the pattern recognition unit 133, may be automatically taught with categories related to an example, recognition of new patterns, detection of uncertain objects, and the like.

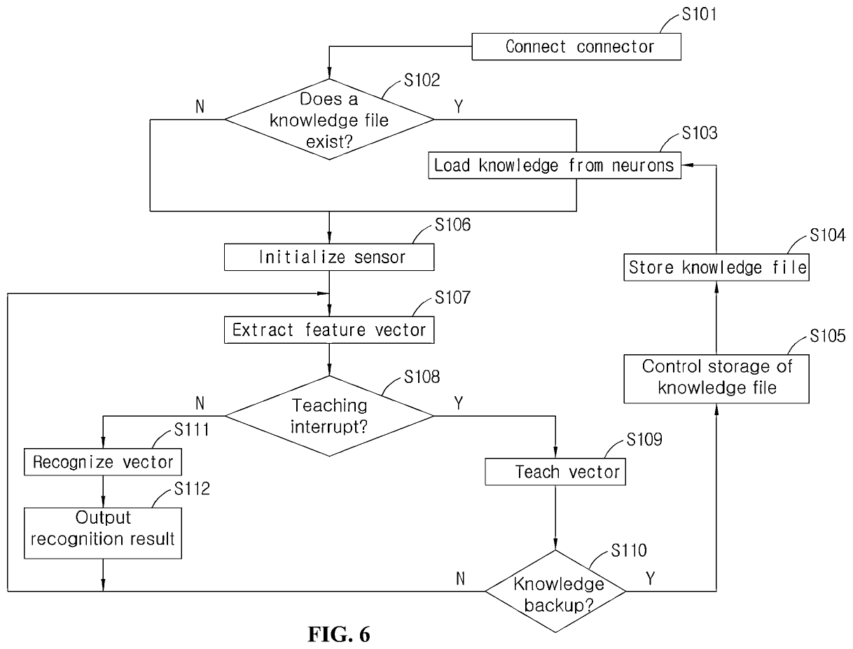

FIG. 6 is a flowchart showing a process of recognizing a pattern vector in a pattern recognition unit 133.

While a CMOS connector is connected, when a knowledge file exists, knowledge may be loaded from neurons (S101 to S103), and when the knowledge file does not exist, or the knowledge is loaded from the neurons, a sensor (meaning a sound sensor) may be initialized (S106).

Next, a feature vector may be extracted from an input sound (S107), and when there is a teaching interrupt, vector teaching may be performed to optimize an artificial intelligence neural network model (S108 and S109). After teaching of the artificial intelligence network model is performed, when knowledge backup is necessary the knowledge may be stored in a knowledge storage file as knowledge built by the neurons (S110, S105, and S104).

Meanwhile, after the feature vector is extracted, when there is no teaching interrupt but vector recognition, the feature vector may be recognized by using the optimized artificial intelligence neural network model (S111 and S112). In this case, the artificial intelligence neural network model may include an input layer, a hidden layer, and an output layer. Sound data, which is input data from an outside of a system, may be received through the input layer so as to be input to the hidden layer. The hidden layer may receive and process an input value, and calculate a result of the processing. The output layer may serve to output the result of the processing performed by the hidden layer as a recognition value.

The result recognized by the pattern recognition unit 133 may be transmitted to the FPGA 132.

The FPGA 132 may standardize the pattern recognized by the pattern recognition unit 133, make the global decision on the pattern, and output the result of the global decision as the voice detection signal. In this case, the voice detection signal may be a signal obtained by distinguishing which object (a motorcycle, a car, a person, an animal, etc.) approaching the car the recognized sound corresponds to.

The voice detection signal distinguished as described above may be linked with a control device provided in the car so as to be displayed through a display and warning device, so that an object that may not be recognized in a field of view of a driver or a field of view of a camera may be recognized through sound recognition so as to be warned and displayed, and thus awareness of the driver may be raised, thereby preventing an accident in advance.

### Embodiment 2

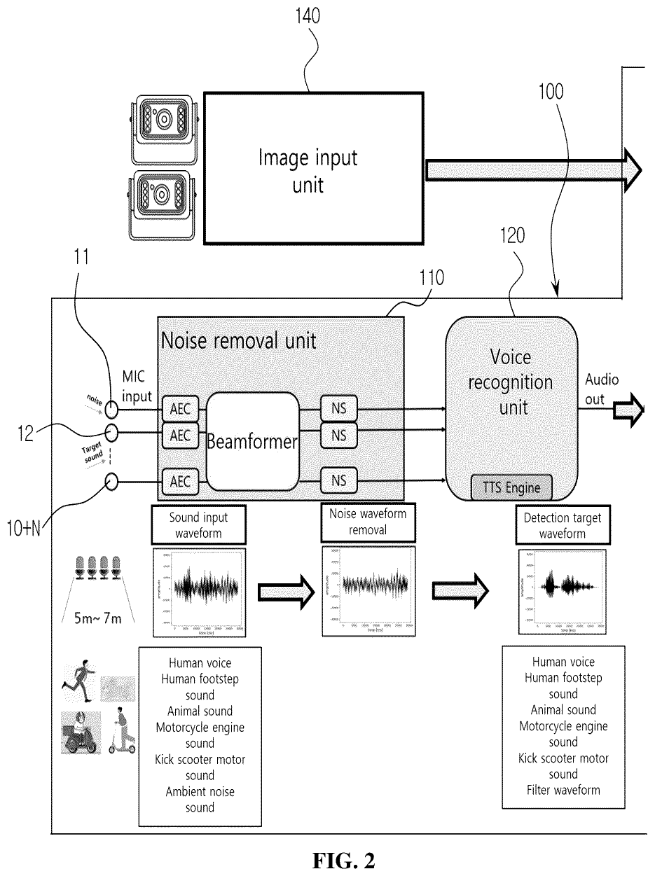

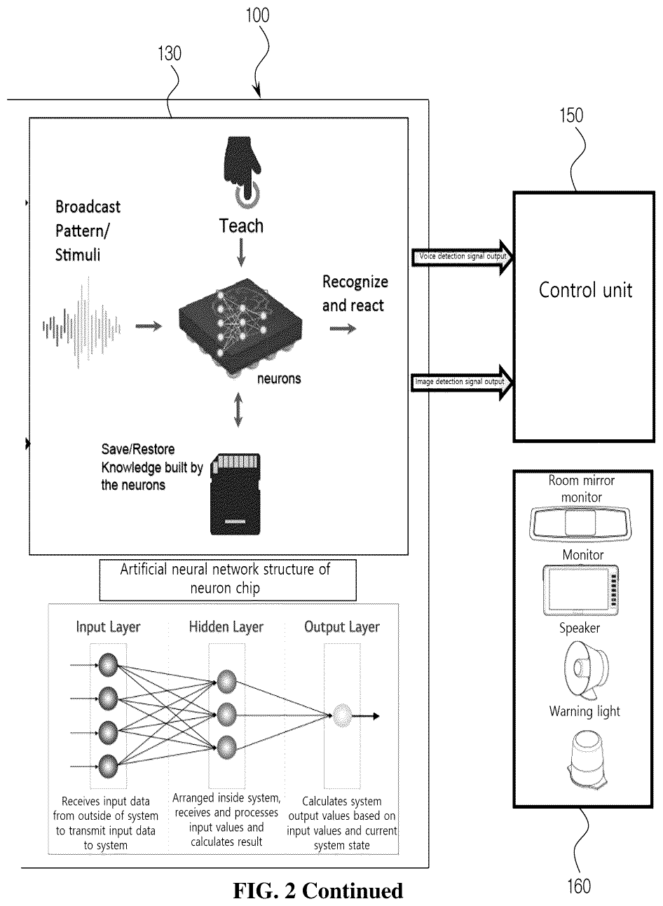

FIG. 2 is a view showing a configuration of “a sound recognition camera using an AI-based sound recognition module” according to the present invention, and a sound recognition camera using an AI-based sound recognition module may include: a sound recognition module 100 including a noise removal unit 110, a voice recognition unit 120, and a sound recognition unit 130; an image input unit 140; a control unit 150; and a warning and display device 160.

The sound recognition module 100 may include: a noise removal unit 110 for removing a noise waveform from a sound input through a microphone based on direction information, and outputting a result of the removal; a voice recognition unit 120 for recognizing only a sound from a waveform output from the noise removal unit 110, and outputting a recognized audio signal; and a sound recognition unit 130 for processing the audio signal output from the voice recognition unit 120 through a neuron artificial neural network to output a voice detection signal.

The noise removal unit 110 may include: a plurality of microphones 10 to 10+N spaced apart from each other at a predetermined interval to determine directionality of the input sound; a coherence function generation unit 111 for calculating coherences of the input sound according to intervals of the microphones 10 to 10+N, respectively, calculating averages of the coherences for each identical distance, filtering the calculated averages of the coherences, and outputting the filtered averages of the coherences; a spatial filter coefficient calculation unit 112 for calculating a spatial filter coefficient by using the filtered averages of the coherence to output the calculated spatial filter coefficient; and a beamforming performance unit 113 for performing beamforming on an input signal by using the spatial filter coefficient to output a noise-processed signal.

The coherence function generation unit 111 may include: a coherence calculation unit 111a for calculating the coherences of the input signal according to microphone intervals in a noise period, respectively, and outputting the calculated coherences; a coherence average calculation unit 111b for calculating average values of the coherences input from the coherence calculation unit 111a for each identical distance, and outputting the calculated average values of the coherences; and a filter unit 111c for filtering the average values of the coherences to smooth out a rapid change according to a frequency, and outputting the filtered average values of the coherences.

The voice recognition unit 120 may recognize only a sound from a waveform output from the noise removal unit 110, and output a recognized audio signal.

The sound recognition unit 130 may process the audio signal output from the voice recognition unit 120 through a neuron artificial neural network, which is artificial intelligence (AI), to output a voice detection signal.

The sound recognition unit 130 may extract a feature from an input audio signal to convert the extracted feature into a pattern vector for teaching or recognition, store the pattern vector obtained through the conversion in a neuron library, recognize a pattern of the pattern vector with a sound recognition model generated through library teaching, standardize the recognized pattern, make a global decision on the pattern, and output a result of the global decision as the voice detection signal.

The sound recognition unit 130 may include: a CMOS connector 131 for receiving the audio signal; a field-programmable gate array (FPGA) 132 for extracting the feature from the audio signal input through the CMOS connector 131 to convert the extracted feature into the pattern vector for the teaching or the recognition; and a pattern recognition unit 133 for storing the pattern vector converted by the FPGA 132 in the neuron library, recognizing the pattern of the pattern vector with the sound recognition model generated through the library teaching, and transmitting a recognition result to the FPGA 132.

In this case, the FPGA 132 may standardize the pattern recognized by the pattern recognition unit 133, make the global decision on the pattern, and output the result of the global decision as the voice detection signal.

The FPGA 132 may standardize the pattern recognized by the pattern recognition unit 133, make the global decision on the pattern, output the result of the global decision as the voice detection signal, and output an image recognition result obtained through the recognition by using the image recognition model.

In addition, the sound recognition unit 130 may include an audio memory 134 for storing audio data, an SDRAM 135 for storing data, a micro SD card 136, a USB terminal, an HDMI terminal, sensor connection terminals J3 to J6 for connecting various sensors, and the like.

Basic configurations and operations of the noise removal unit 110, the voice recognition unit 120, and the sound recognition unit 130 are substantially the same as the basic configurations and operations of the noise removal unit, the voice recognition unit, and the sound recognition unit of <Embodiment 1>.

However, a function of receiving an image acquired through a camera, preprocessing the received image to convert the image into a recognition image, and recognizing the recognition image obtained through the conversion to output the recognized recognition image as the image detection signal has been added to the sound recognition unit 130 in addition to sound recognition.

The image input unit 140 may serve to receive an image acquired through a camera, preprocess the received image to convert the image into a recognition image, and transmit the recognition image to the sound recognition module 100.

The control unit 150 may serve to control warning and display based on the voice detection signal output from the sound recognition module 100, and the warning and display device 160 may serve to perform the warning and display based on voice sound detection according to a warning and display control signal generated by the control unit 150.

According to Embodiment 2 configured as described above, a sound recognition camera may be implemented by additionally adding a sound recognition module to a camera mounted on a general car and the like to assist a driver.

Since a process of recognizing a sound in the sound recognition module is the same as the process of recognizing the sound according to the technical description in <Embodiment 1>, in order to avoid redundant descriptions, the description in <Embodiment 1> will be referred to.

The image input unit 140 may receive the image acquired through the camera, preprocess the received image to convert the image into the recognition image, and transmit the recognition image to the sound recognition module 100.

The sound recognition unit 130 of the sound recognition module 100 may perform sound recognition in the same way as in Embodiment 1, preprocess the received image to convert the image into the recognition image when the image acquired through the camera is received, and recognize the recognition image obtained through the conversion to output the recognized recognition image as an image detection signal. In this case, a scheme of recognizing an image from an image captured by a camera may adopt an existing scheme of recognizing an image captured through a camera in an advanced driver assistance system (e.g., ADAS) added to a car for use.

The control unit 150 may control the warning and display based on the voice detection signal output from the sound recognition module 100, and control the warning and display based on the image detection signal output from the sound recognition module 100.

In other words, the transmitted voice detection signal may be a signal recognized through sound recognition performed on an object that may not be recognized in a field of view of a driver and a field of view of a camera so as to be transmitted, and warning display through a monitor or the like and a warning device such as a speaker and a warning light may be performed and driven to raise awareness of the driver, thereby preventing an accident in advance.

In addition, the transmitted image detection signal may be an object detection signal captured by a camera, and warning display through a monitor or the like and a warning device such as a speaker and a warning light may be performed and driven to raise awareness of the driver, thereby preventing an accident in advance.

The warning and display device 160 may perform the warning and display based on voice sound detection according to a warning and display control signal caused by voice detection, which is generated by the control unit 150, and may perform the warning and display based on image detection according to a warning and display control signal caused by the image detection.

In this case, the warning and display device 160 may use various warning and display devices provided in the car. For example, a display signal based on the image detection or the sound detection may be displayed by using a room mirror monitor, a navigation monitor, an audio system monitor, or the like, and a display signal based on the image detection or the sound detection may be output by using a speaker, a warning light, or the like, so that the driver may recognize the presence of an object approaching the car and drive safely.

Although the invention invented by the present inventor has been described in detail according to the above embodiments, the present invention is not limited to the embodiments, and it is obvious to a person having ordinary skill in the art that various changes can be made without departing from the gist of the present invention.

What is claimed is:

1. An AI-based sound recognition module comprising:
a noise removal unit for removing a noise waveform from a sound input through a microphone based on direction information, and outputting a result of the removal;
a voice recognition unit for recognizing only a sound from a waveform output from the noise removal unit, and outputting a recognized audio signal; and
a sound recognition unit for processing the audio signal output from the voice recognition unit through a neuron artificial neural network to output a voice detection signal,
wherein the sound recognition unit extracts a feature from an input audio signal to convert the extracted feature into a pattern vector for teaching or recognition, stores the pattern vector obtained through the conversion in a neuron library, recognizes a pattern of the pattern vector with a sound recognition model generated through library teaching, standardizes the recognized pattern, makes a global decision on the pattern, and outputs a result of the global decision as the voice detection signal.

2. The AI-based sound recognition module of claim 1, wherein the noise removal unit includes:
a plurality of microphones spaced apart from each other at a predetermined interval to determine directionality of the input sound;
a coherence function generation unit for calculating coherences of the input sound according to microphone intervals, respectively, calculating averages of the coherences for each identical distance, filtering the calculated averages of the coherences, and outputting the filtered averages of the coherences;
a spatial filter coefficient calculation unit for calculating a spatial filter coefficient by using the filtered averages of the coherences to output the calculated spatial filter coefficient; and
a beamforming performance unit for performing beamforming on an input signal by using the spatial filter coefficient to output a noise-processed signal.

3. The AI-based sound recognition module of claim 2, wherein the coherence function generation unit includes:
a coherence calculation unit for calculating the coherences of the input signal according to microphone intervals in a noise period, respectively, and outputting the calculated coherences;
a coherence average calculation unit for calculating average values of the coherences input from the coherence calculation unit for each identical distance, and outputting the calculated average values of the coherences; and
a filter unit for filtering the average values of the coherences to smooth out a rapid change according to a frequency, and outputting the filtered average values of the coherences.

4. The AI-based sound recognition module of claim 1, wherein the sound recognition unit includes:
a CMOS connector for receiving the audio signal;
a field-programmable gate array (FPGA) for extracting the feature from the audio signal input through the CMOS connector to convert the extracted feature into the pattern vector for the teaching or the recognition; and
a pattern recognition unit for storing the pattern vector converted by the FPGA in the neuron library, recognizing the pattern of the pattern vector with the sound recognition model generated through the library teaching, and transmitting a recognition result to the FPGA, and
the FPGA standardizes the pattern recognized by the pattern recognition unit, makes the global decision on the pattern, and outputs the result of the global decision as the voice detection signal.

5. A sound recognition camera using an AI-based sound recognition module, the sound recognition camera comprising:
the sound recognition module including a noise removal unit for removing a noise waveform from a sound input through a microphone based on direction information and outputting a result of the removal, a voice recognition unit for recognizing only a sound from a waveform output from the noise removal unit and outputting a recognized audio signal, and a sound recognition unit for processing the audio signal output from the voice recognition unit through a neuron artificial neural network to output a voice detection signal;
an image input unit for receiving an image acquired through a camera, preprocessing the received image to convert the image into a recognition image, and transmitting the recognition image to the sound recognition module;
a control unit for controlling warning and display based on the voice detection signal output from the sound recognition module; and
a warning and display device for performing the warning and display based on voice sound detection according to a warning and display control signal generated by the control unit,
wherein the sound recognition module recognizes the recognition image converted by the image input unit to output the recognized recognition image as an image detection signal,
the control unit controls the warning and display based on the image detection signal, and
the warning and display device performs the warning and display based on image detection.

6. The sound recognition camera of claim 5, wherein the noise removal unit includes:
a plurality of microphones spaced apart from each other at a predetermined interval to determine directionality of the input sound;
a coherence function generation unit for calculating coherences of the input sound according to microphone intervals, respectively, calculating averages of the coherences for each identical distance, filtering the calculated averages of the coherences, and outputting the filtered averages of the coherences;
a spatial filter coefficient calculation unit for calculating a spatial filter coefficient by using the filtered averages of the coherences to output the calculated spatial filter coefficient; and
a beamforming performance unit for performing beamforming on an input signal by using the spatial filter coefficient to output a noise-processed signal.

7. The sound recognition camera of claim 5, wherein the sound recognition unit includes:
a CMOS connector for receiving an image signal and the audio signal;
a field-programmable gate array (FPGA) for extracting a feature from the audio signal input through the CMOS connector to convert the extracted feature into a pattern vector for teaching or recognition, preprocessing the image signal, and recognizing the image signal with an image recognition model; and
a pattern recognition unit for storing the pattern vector converted by the FPGA in a neuron library, recognizing a pattern of the pattern vector with a sound recognition model generated through library teaching, and transmitting a recognition result to the FPGA, and
the FPGA standardizes the pattern recognized by the pattern recognition unit, makes a global decision on the pattern, outputs a result of the global decision as the voice detection signal, and outputs an image recognition result obtained through the recognition by using the image recognition model.
